(19) United States
(12) Patent Application Publication
(10) Pub. No.: US 2011/0261769 A1
(43) Pub. Date: Oct. 27, 2011

(54) METHOD AND APPARATUS FOR CONTROLLING INTER-CELL INTERFERENCE OF CONTROL CHANNELS IN OFDM-BASED HIERARCHICAL CELLULAR SYSTEM

(75) Inventors: Hyoung Ju JI, Seoul (KR); Joon Young CHO, Suwon-si (KR); Ju Ho LEE, Suwon-si (KR)

(73) Assignee: SAMSUNG ELECTRONICS CO. LTD., Suwon-si (KR)

(21) Appl. No.: 13/093,158

(22) Filed: Apr. 25, 2011

(30) Foreign Application Priority Data
Apr. 26, 2010 (KR) 10-2010-0038693

(51) Int. Cl. H04W 72/04; H04L 27/28

(52) U.S. Cl. 370/329

(57) ABSTRACT

A method and apparatus for controlling inter-cell interference of control channels of hierarchical cells in a hierarchical cellular system based on Orthogonal Frequency Division Multiplexing (OFDM) are provided. The inter-cell interference control method of a base station in a hierarchical cellular system based on Orthogonal Frequency Division Multiplexing (OFDM) includes transmitting a broadcast channel, including information on an available bandwidth that is a part of an entire bandwidth, to a terminal, transmitting a control channel including data channel allocation information for the entire bandwidth to the terminal, and transmitting a data channel, as informed by the data channel allocation information, to the terminal. The inter-cell interference control method and apparatus support cooperative transmission of hierarchical cells while maintaining both backward compatibility and forward compatibility.

### PRIORITY

This application claims the benefit under 35 U.S.C. §119(a) of a Korean patent application filed on Apr. 26, 2010 in the Korean Intellectual Property Office and assigned Serial No. 10-2010-0038693, the entire disclosure of which is hereby incorporated by reference.

### BACKGROUND OF THE INVENTION

1. Field of the Invention

The present invention relates to a cellular communication system. More particularly, the present invention relates to a method and apparatus for controlling inter-cell interference of control channels in a hierarchical cellular system based on Orthogonal Frequency Division Multiplexing (OFDM).

2. Description of the Related Art

Mobile communication systems provide users with voice communication services on the move. With advancing technologies, the mobile communication systems have evolved to support high speed data communication services as well as the standard voice communication services. However, there is a need of more sophisticated mobile communication systems to mitigate resource shortage and meet the high-speed service requirements of the users.

Long Term Evolution (LTE) is a next generation broadband communication technology developed by the 3rd Generation Partnership Project (3GPP). LTE is designed to provide downlink speeds of up to 100 Mbps and was commercially launched in 2010. In order to fulfill the requirements for the LTE systems, studies have been done in various aspects including minimization of the number of involved nodes in the connections and placing the radio protocol as close as possible to the radio channels.

Inter-Cell Interference Coordination (ICIC) is a technique introduced in LTE to reduce Inter-Cell Interference (ICI) by sharing information on a currently used data channel resource among the cells, thereby keeping the ICI under control via a base station. In an LTE system, data channel resources are assigned to each user in units of Resource Blocks (RBs) but are distributed across an entire system bandwidth for a control channel. Also, since the resource is assigned in unit of Resource Element Group (REG) for the control channel, ICIC is not applied to the control channel. In particular, the LTE-Advanced (LTE-A) system, as the evolved version of LTE system, is designed having a hierarchal cellular structure in which a plurality of tiny cells are distributed within a legacy cell. A cellular structure composed of a macro cell including one or more femto cells or relays can be an exemplary hierarchical cellular structure. In the hierarchical cellular structure, interference in the macro cell increases significantly and thus it becomes more difficult to receive the control channel to which the ICIC cannot be adopted. There is therefore a need of an ICIC technique that can be adopted to the control channel in the hierarchical cellular system.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for mitigating inter-cell interference of control channels of the cells using the same frequency band in a hierarchical cellular system.

Another aspect of the present invention is to provide a method and apparatus for mitigating inter-cell interference that enables both the Long Term Evolution (LTE) and LTE-Advanced (LTE-A) terminals to receive the Inter-Cell-Interference-Coordination (ICIC) applied control channel.

In order to address the aforementioned problems, the ICI control method and apparatus for controlling ICI of a control channel of a Heterogeneous Network (HetNet) cell in a hierarchical cellular system based on Orthogonal Frequency Division Multiplexing(OFDM) includes dividing a control channel resource for ICIC, configuring ICIC control channel resource information, determining a Control Format Indicator (CFI) value and a Physical Hybrid Automatic Repeat Request (ARQ) Indicator Channel (PHICH) configuration value for ICIC, transmitting the configured information in a Physical Control Format Indicator Channel (PCFICH), transmitting the configured information in a Physical Broadcast Channel (PBCH), transmitting the configured information by higher layer signaling, acquiring subframe synchronization between hierarchical cells, acquiring data channel synchronization between hierarchical cells, configuring a Physical Downlink Shared Channel (PDSCH) of a LTE terminal with allocation of time-frequency resources, configuring PDSCH of a LTE-A terminal with allocation of time-frequency resources, adjusting a data transmit power of symbols, allocating power only for a reference signal in the control channel region for ICIC, and designating an uplink control channel region according to a control channel bandwidth of the HetNet cell.

In accordance with an aspect of the present invention, an inter-cell interference control method of a base station in a hierarchical cellular system based on OFDM is provided. The method includes transmitting a broadcast channel, including information on an available bandwidth that is a part of an entire bandwidth, to a terminal, transmitting a control channel including data channel allocation information for the entire bandwidth to the terminal, and transmitting a data channel, as informed by the data channel allocation information, to the terminal.

In accordance with another aspect of the present invention, a method for receiving control and data channels of a terminal in a hierarchical cellular system based on OFDM is provided. The method includes receiving a broadcast channel including information on an available bandwidth that is a part of an entire bandwidth, receiving a control channel including data channel allocation information for the entire bandwidth, and receiving a data channel according to the data channel allocation information.

In accordance with another aspect of the present invention, a base station for controlling inter-cell interference in a hierarchical cellular system based on OFDM is provided. The base station includes a controller for generating a broadcast channel including information on an available bandwidth that is a part of an entire bandwidth, a control channel including data channel allocation information for the entire bandwidth, and a data channel based on the data channel allocation information, and a transceiver for transmitting the broadcast channel, the control channel, and the data channel to a User Equipment (UE).

In accordance with still another aspect of the present invention, a terminal for receiving control and data channels in a hierarchical cellular system based on OFDM is provided. The terminal includes a transceiver for receiving the control and data channels transmitted by a base station and a controller for receiving and processing a broadcast channel including information on an available bandwidth that is a part of an entire bandwidth, a control channel including data channel allocation information for the entire bandwidth, and a data channel according to the data channel allocation information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates structures of subframes for use in a Long Term Evolution (LTE) and a LTE-Advanced (LTE-A) system to which an Inter-Cell Interference (ICI) control method is applied according to an exemplary embodiment of the present invention;

FIG. 2 illustrates a hierarchical cellular radio environment considered in the LTE-A system according to an exemplary embodiment of the present invention;

FIG. 3 illustrates a principle of data communications and an ICI Coordination (ICIC) technique in the LTE-A system according to an exemplary embodiment of the present invention.

FIG. 4 illustrates a structure of an ICIC control channel in an Orthogonal Frequency Division Multiplexing (OFDM) based hierarchical cellular system according to an exemplary embodiment of the present invention;

FIG. 5 illustrates a signaling procedure for a LTE-A ICIC according to an exemplary embodiment of the present invention;

FIG. 6A illustrates structures of an uplink control channel for indicating different bandwidths to LTE User Equipment (UE) and LTE-A UE in a HetNet cell according to an exemplary embodiment of the present invention;

FIG. 6B illustrates a structure of a scheduling control channel information received by a LTE UE and a LTE-A UE within the HetNet cell in a bandwidth information acquisition process according to an exemplary embodiment of the present invention;

FIG. 7 is a flowchart illustrating operations of a transmitter of evolved Node B (eNB) according to an exemplary embodiment of the present invention;

FIG. 8 is a flowchart illustrating operations of a UE for receiving data according to an exemplary embodiment of the present invention;

FIG. 9 is a flowchart illustrating operations of a UE for receiving data according to an exemplary embodiment of the present invention;

FIG. 10 is a block diagram illustrating a configuration of an eNB according to an exemplary embodiment of the present invention; and

FIG. 11 is a block diagram illustrating a configuration of a receiver of a UE according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the term Long Term Evolution (LTE) User Equipment (UE) or “LTE UE” (hereinafter, used interchangeably with the term “first UE”) is a terminal which does not support carrier aggregation, and the term LTE-Advanced or “LTE-A UE” (hereinafter, used interchangeably with the term “second UE”) is a terminal which supports carrier aggregation.

The LTE system adopts the aforementioned Orthogonal Frequency Division Multiplexing (OFDM) in downlinks and Single Carrier-Frequency Division Multiple Access (SC-FDMA) in uplinks. The LTE-A system evolved from the LTE system to use multiple carriers.

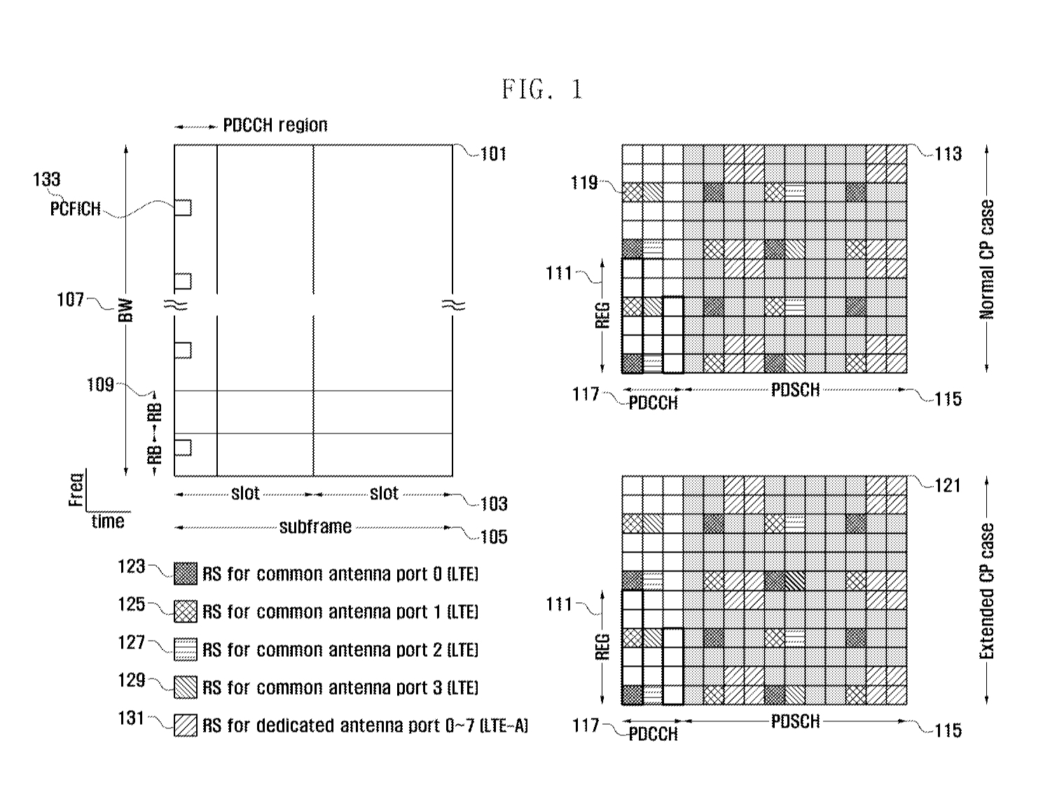

FIG. 1 illustrates structures of subframes for use in the LTE and LTE-A system to which the inter-cell interference control method is applied according to an exemplary embodiment of the present invention.

Referring to FIG. 1, the entire LTE transmission bandwidth 107 is composed of a plurality of Resource Blocks (RBs) 109, and each of the RBs 109 is composed of 12 frequency tones arranged in frequency domain and 14 OFDM symbols 113 or 12 OFDM symbols 121 and a basic unit of resource allocation. A subframe 105 has a length of 1 ms and is composed of two slots 103. A subframe consisting of 14 OFDM symbols is referred to as a normal Cyclic Prefix (CP) subframe 113, and a subframe consisted of 12 OFDM symbols is referred to as an extended CP subframe 121.

Meanwhile, a Common Reference Signal (CRS) 119 is predefined to be transmitted from an evolved Node B (eNB) to User Equipment (UE) for use in channel estimation at the UE and transmitted across the entire system bandwidth for antenna port 0 123, antenna port 1 125, antenna port 2 127, and antenna port 3 129 as shown in FIG. 1. Here, if the number of antenna ports is one or more, then multi-antenna transmission is being performed. Absolute positions of the CRSs arranged on a frequency axis in a RB are configured differently according to the cell, but a relative distance between CRSs is maintained to be at a regular interval. That is, the CRSs for the same antenna port are arranged at an interval of 6 RBs. The reason why the absolute positions of the CRSs are different for different cells is to avoid Inter-Cell Interference (ICI) of the CRSs. A number of the CRSs is determined differently per an antenna port such that there are 8 CRSs for each of the antenna ports 0 and 1 and there are 4 CRSs for each of the antenna ports 2 and 3. In a case of using 4 antennas, a channel estimation accuracy with the antenna ports 2 and 3 is worse than a channel estimation accuracy with the antenna ports 0 and 1.

In addition to the CRSs, a Dedicated Reference Signal (DRS) is another type of reference signal. The DRS is used for antenna beamforming in order for the eNB to transmit data to a certain recipient. The DRS is transmitted in a Physical Resource Block (PRB) assigned to the recipient but is not transmitted across the entire system bandwidth. The recipient can perform data channel demodulation with the DRS received on the corresponding resource.

A pattern 131 is the DRS used in the LTE-A system. In the LTE-A system, a total of 24 Resource Elements (REs) are assigned for the DRS in a subframe, and the 24 DRSs are used for up to 8 multiplexed antennas. The LTE UE cannot use the DRS 131, and the LTE-A UE can use both the CRS and DRS.

Meanwhile, the control channel signal is arranged at a beginning of each subframe in the time domain. In FIG. 1, the reference number 117 denotes the region in which the control channel (referred to as a Physical Downlink Control Channel (PDCCH)) is carried. The control channel signal is carried in L OFDM symbols at the beginning of the subframe, wherein L can be 1, 2, or 3. In FIG. 1, the control signal region 117 is composed of 3 OFDM symbols. In a case that one OFDM symbol is allocated for the control signal due to there being a small amount of control channel information (L=1), the remaining 13 OFDM symbols of the subframe are used for data channel transmission. The value of L is used as the basic information for demapping the control channel from the control channel resource in the reception process such that, if the value of L is not received, it is impossible to recover the control channel. The control signal is located at the beginning of the subframe in order to first notify the UE of the information on whether there is the data channel signal transmitted to the UE, such that the UE can determine whether to perform operations for receiving a data channel signal. If there no data channel signal transmitted to the UE, it is not necessary for the UE to perform the operations for receiving the data channel signal so as to save power consumption. Also, since the UE can receive the control channel more quickly than the data channel, it is possible to reduce a scheduling delay.

The LTE standard specifies three downlink control channels: the Physical Control Format Indicator Channel (PCFICH) 133, a Physical Hybrid Automatic Repeat Request (ARQ) Indicator Channel (PHICH), and the PDCCH that are transmitted in the control region 117 in units of Resource Element Group (REG) 111, as shown in FIG. 1.

The PCFICH 133 is a physical channel for transmitting a Control Channel Format Indicator (CFI). The CFI is a 2-bit indicator for indicating L, which is the number of symbols assigned for the control channel in a subframe. Since the number of symbols assigned for the control channel is indicated by the CFI, all of the UEs have to receive the CFI first in the subframe, except when the downlink resource is allocated semi-persistently. Also, since the value of L can be acquired from the PCFICH, the PCFICH should be transmitted in the first OFDM symbol of each subframe. The PCFICH is divided into 4 parts for 16 subcarriers and transmitted across the entire bandwidth.

The PHICH is a physical channel for transmitting a downlink Acknowledgement/Negative Acknowledgement (ACK/NACK) signal. The PHICH is received by the UE transmitting data through an uplink. Accordingly, a number of PHICHs is proportional to a number of UEs that are transmitting through uplinks. The PHICH can be transmitted in the first OFDM symbol (LPHICH=1, which is a normal mode) or across three OFDM symbols (LPHICH=3, which is an extended mode). The information on the PHICH, including the number of symbols, or LPHICH, is transmitted from the eNB to the UEs within the cell at an initial access of the cell. Like the PCFICH, the PHICH is transmitted in positions designated per cell. Accordingly, the PHICH can be received after receipt of Primary Broadcast Channel (PBCH) information, regardless of other control channels.

The PDCCH 117 is a physical channel for transmitting data channel allocation information and/or power control information. The PDCCH can be configured with different channel coding rates according to a channel condition of the UE. Since the eNB uses Quadrature Phase Shift Keying (QPSK) as a fixed modulation scheme of the PDCCH the amount of resources allocated for the PDCCH should be changed in order to change a channel coding rate. That is, a base station uses a high channel coding rate for a mobile terminal of which channel conditions are good so as to reduce the amount of resources for data transmission. In contrast, the base station uses a low channel coding rate for the mobile terminal of which channel conditions are bad in order to increase the reception probability of the mobile terminal even at the cost of using large amounts of resources. The resource amount assigned for each PDCCH is determined in units of Control Channel Element (CCE). A CCE consists of a plurality of REGs 111. The REG 111 is placed in the control channel region 117 after being interleaved to obtain diversity gain.

In order to multiplex several ACK/NACK signals, a Code Domain Multiplexing (CDM) technique is applied for the PHICH. In a single REG 111, 8 PHICH signals are multiplexed into 4 real number parts and 4 imaginary number parts by means of the CDM technique and repeated as many as NPHICH, wherein N is a real number, so as to be distributed in the frequency domain in order to obtain frequency diversity gain. By using NPHICH REGs, it is possible to form the 8 or less PHICH signals. In order to form the more than 8 PHICH signals, it is necessary to use other NPHICH REGs 111 should be used.

After assigning the PCFICH and PHICH, a scheduler determines the value of L, maps the physical channels to the REG 111 of the assigned control channel region 117 based on the value of L, and performs interleaving to obtain frequency diversity gain. The interleaving is performed on the total REGs 111 of the subframe 101 determined by the value of L in units of REG 111 in the control channel region 117. The output of the interleaver in the control channel region 117 is capable of preventing ICI caused by using a same interleaver for the cells and obtaining the diversity gain by distributing the REGs 111 of the control channel region 117 across one or more symbols. Also, it is guaranteed that the REGs 111 forming the same control channel are distributed uniformly across the symbols per control channel.

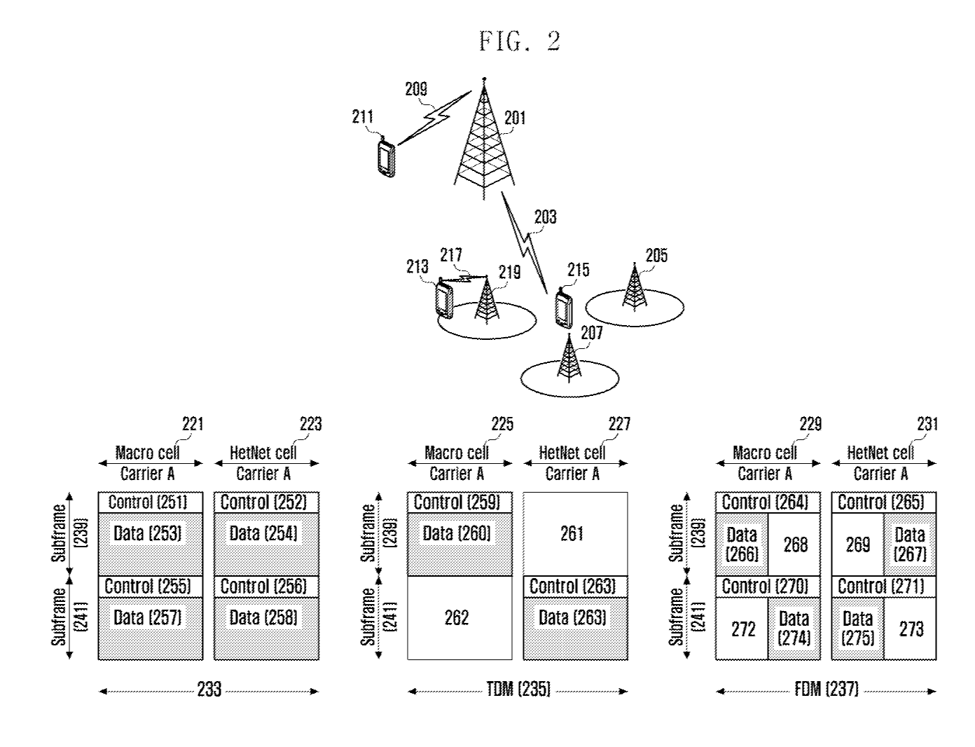

FIG. 2 illustrates a hierarchical cellular radio environment considered in the LTE-A system according to an exemplary embodiment of the present invention.

Referring to FIG. 2, in a LTE-A system, the hierarchical cellular network is called Heterogeneous Network (HetNet). That is, a HetNet is the hierarchical cellular network including a legacy macro cell 201 and micro cells 219, 205, and 207. In the following description, a higher ranking cell is referred to as a macro cell, and a lower ranking cell is referred to as a HetNet cell. However, the present invention is not limited thereto, and this differentiation is made only for the purpose of simplicity, and the same base station can be classified into a macro cell or a HetNet cell logically, wherein it is not necessary for a macro cell to include a HetNet cell. That is, the macro cell and the HetNet cell are not necessarily in a hierarchical relationship, but alternatively, the macro cell and the HetNet cell can be in a peer-to-peer relationship. For the purpose of simplicity, the macro cell and the HetNet cell can be referred to as a first cell and a second cell, respectively.

In a case where the communication system is designed in the hierarchical cellular structure including the macro and HetNet cells, it is not necessary to change the transmit power of a conventional macro cell. Accordingly, interference in the macro cell, caused by the HetNet cells, increases in proportion to a number of HetNet cells. Except for the UEs located near the eNB, most of the UEs are impacted by high interference and may even fail to receive the control channel due to the interference. Especially in the environment where the macro and HetNet cells are using a same frequency band, the problem may become worse because there is no way to distribute interference within the same frequency band. However, it is possible to distribute the interference when the macro and HetNet cells are using different frequency bands. In a case where the macro and HetNet cells use the same frequency band, the interference occurs between a macro cell control channel 251 and a HetNet cell control channel, as well as between the macro cell data channel 253 and the HetNet cell data channel 254.

In the case of a data channel, it is possible to mitigate the interference by exchanging frequency resource allocation information among the cells. However, this method cannot be applied to the control channel in the hierarchical cellular environment since each cell uses the resource that is allocated randomly across the entire bandwidth.

According to the present exemplary embodiment, there are two ways of applying the Inter-Cell Interference Coordination (ICIC) to the control channel. A first way is applied to a Time Division Multiplex (TDM) system, and a second way is applied to a Frequency Division Multiplex (FDM) system. In the TDM system, a macro cell 225 and a HetNet cell 227 use the different subframes, 239 and 241, respectively, in the time domain. That is, the subframe 239 is used by the macro cell 225 and the subframe 241 is used by the HetNet cell 224 while the macro cell 225 does not transmit any signal. In the TDM system, an actual efficiency of available resources is reduced by as much as a half for both the control and data channels, even though there is no ICI. During a period of an idle subframe, the TDM system cannot use a Hybrid ARQ (HARQ) cycle, resulting in decreased system throughput.

In the FDM system, the data channels can be multiplexed in the frequency domain, as denoted by reference number 229 and 231, while there cannot be multiple control channels in the frequency domain due to a structure of the LTE system.

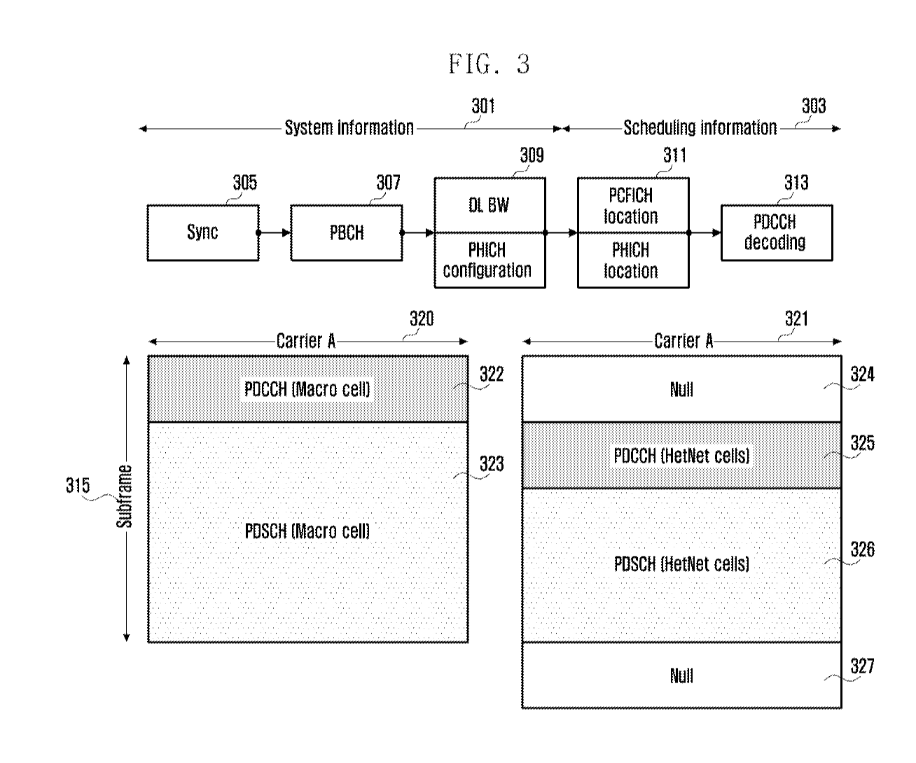

FIG. 3 illustrates a principle of data communication and an ICIC technique in an LTE-A system according to an exemplary embodiment of the present invention.

Referring to FIG. 3, an initial procedure in which a UE receives a signal from an eNB and a transmitting/receiving data channel is shown. In order for the UE to receive scheduling information 303, system information 301 should first be received. The system information 301 includes basic information used to receive the scheduling information 303 for the UE. First of all, the UE identifies a cell based on a synchronization signal 305. Next, the UE receives a Physical Broadcast Channel (PBCH) 307 from the identified cell. The PBCH 307 includes a downlink bandwidth and PHICH configuration information 309 and other information. After receiving the PBCH 307, the UE can receive a control channel region of the subframe. The UE first receives a PCFICH location 311 of the control channel region in order to check a size of the control channel and prepares for PDCCH demodulation by combining the PHICH configuration information 309 received in the PBCH 307. Next, the UE receives a PDCCH 313 in order to acquire scheduling information. That is, the UE should know the Downlink Bandwidth (DL BW), the PCFICH 311, and the PHICH configuration information 309 in order to demodulate the PDCCH 313. Before receiving the PDCCH 313, the UE cannot receive any information for the ICIC of the control channel. Since a start point of the data channel symbol is associated with the value received in the PCFICH 313, a size of the control channel is not changed without changing the data channel.

In order to address these problems, a time shifting technique is proposed, as shown with macro cell subframe 320 and HetNet cell subframe 321. In the time shifting method, the HetNet cell subframe 321 is time-shifted in a region occupied by the PDCCH 322 of the macro cell such that a data channel amount decreases as much as the amount of the time shifting to protect the control channel region from ICI, under the condition that the subframe synchronization are accurately maintained between the hierarchical cells. This method can protect the control channel region for the macro cell but not the control channel region for the HetNet cell and may reduce the cell throughput by as much as approximately 30% due to a reduction of the data channel amount for the HetNet. Accordingly, there is a need of a method for protecting both the control channels of the macro and HetNet cells from ICI. In a case wherein the control channel is designed to support the ICIC, however, the LTE UE cannot acquire new control channel information in the current UE access and system information acquisition procedure, thus, resulting in no benefit from the ICIC. That is, a backward compatibility problem occurs. Therefore, there is a need of a method for protecting the control channels of both the macro cell and the HetNet cell from ICI while guaranteeing backward compatibility of the ICIC between control channels to the legacy UE.

Although the description is directed to a UE for the simplicity purpose, the technique described herein can be adopted to a relay as well as UE.

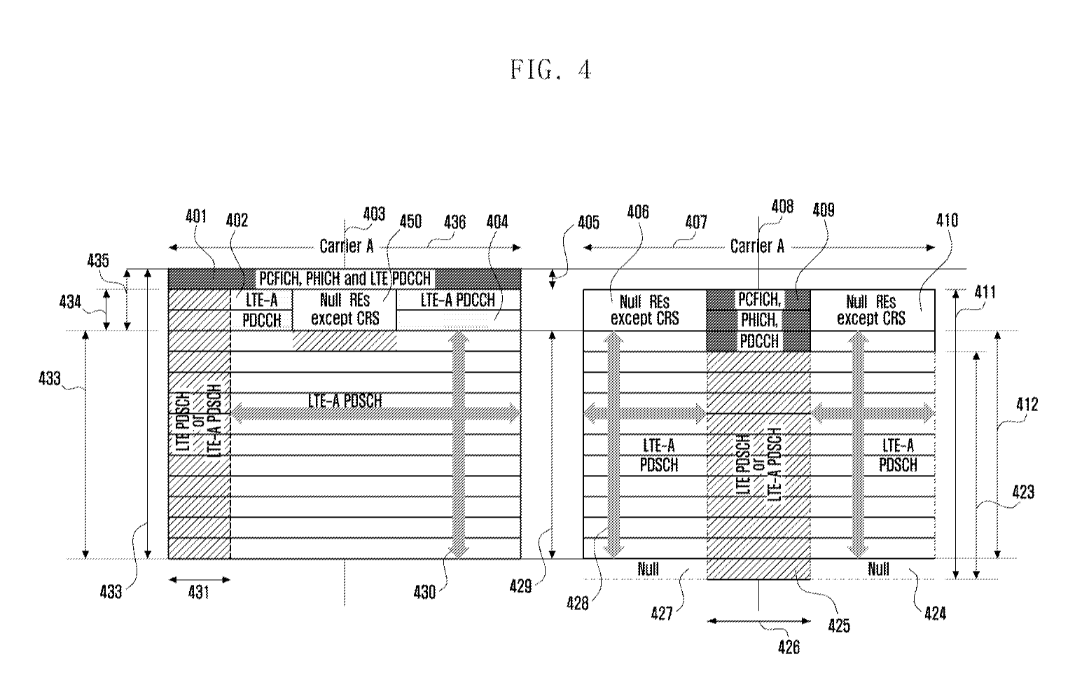

FIG. 4 is a diagram illustrating a structure of an ICIC control channel in an OFDM-based hierarchical cellular system according to an exemplary embodiment of the present invention.

The exemplary embodiment extends bandwidth information of the control channel, configures control channel regions of the hierarchical cells independently from each other, and protects the control channels of the macro and HetNet cells from ICI with the data channel synchronization.

Referring to FIG. 4, a macro cell subframe 436 and HetNet cell subframe 407 are shown. In the macro cell subframe 436, the value of a PCFICH, PHICH and LTE PDCCH region 401 is fixed to a variable N, wherein N can be set to one of 1 to 4. The macro cell subframe 436 and the HetNet cell subframe 407 are synchronized with each other by shifting the HetNet cell subframe 407 by as much as N symbols, as denoted by reference number 405.

Once the HetNet cell subframe 407 that is shifted by as much as N symbols is synchronized with the macro cell subframe 436, the PCFICH, PHICH and LTE PDCCH region 401 of the macro cell subframe 436 can be protected from the interference caused by the HetNet cell. At this time, the PHICH configuration adjusted to fit a size of PDCCH, which is N symbols. That is, when N is 1 or 2, the subframe is configured in normal mode and, when N is 3 or greater, the subframe is configured in extended mode. The macro subframe 436 is a case when N is 1, which also indicates that the PHICH is configured normally such that only a first symbol is used for transmitting an LTE control channel. Once the control signal is received, the UE is scheduled for a data channel from an (N+1)^{th} symbol, as denoted by reference number 431. The remainder of a control channel region 434 can be received by only the LTE-A UE, except for a region 450 of the control channel region 434. The control channel for the LTE-A UE is transmitted in the regions 402 and 404. The region 450 is used for the transmission of a reference signal, and is used to transmit the control channel in the HetNet cell subframe 407.

Meanwhile, the region 450, which is also referred to as a HetNet cell control channel 450, is configured to be narrower than the entire bandwidth. In this case, the legacy LTE UE recognizes a bandwidth narrower than an actual bandwidth as the available bandwidth. That is, although the actual bandwidth that can be used by the legacy LTE UE has the size of the HetNet cell subframe 407, the eNB notifies the LTE UE that the available bandwidth is a size of a region 409. The remaining regions 406 and 410 are used for transmitting the reference signals and corresponds to the macro cell subframe 436, and the macro cell transmits the reference signal in this region.

A PCFICH value K, which determines a size of the control channel region of the HetNet cell subframe 406 is variable. The LTE UE only recognizes a region 426 as the available bandwidth so that the LTE UE is scheduled in the region 426 with the data channel starting from a (K+1)^{th} symbol. Unlike the LTE UE, the LTE-A UE can detect the entire bandwidth, which is larger than the bandwidth of the region 426, as available in the HetNet cell so as to receive a data channel across the entire bandwidth.

In order to avoid interference with a macro cell control channel 401 and support a coordinated transmission between the macro and HetNet cells, it is preferred that the data channel starts from (K+1−N)^{th} symbol.

The above-described method can be summarized as described below.

In the macro cell, the LTE UE can acquire the macro cell control channel 401 without interference using the conventional system information and can receive the data channel based on the control channel information. Meanwhile, the LTE-A UE can acquire information on the new control channel in the region except for the control channel region used in the HetNet cell from the next symbol of the control channel used by the LTE terminal and can receive the control channel without interference. Also, the data channel transmission starts from the symbol after the maximum available PDCCH.

In the HetNet cell, both the LTE UE and LTE-A UE receive the control channel in the same region. In this case, the eNB configures the transmission bandwidth to be narrower than the available bandwidth in the HetNet cell in order to transmit the PBCH. Accordingly, the LTE UE recognizes a bandwidth narrower than the actual bandwidth to be the available bandwidth. In a case of the LTE-A UE, however, the eNB notifies the LTE-A UE of the entire bandwidth that can be actually used in addition to the bandwidth used for the control channel in HetNet cell. Accordingly, the LTE-A UE can receive the data channel through the entire bandwidth in the HetNet cell, which is wider than the bandwidth available for the LTE terminal in the HetNet cell.

The start and end points of the HetNet cell subframe carrying the control channel and data channel may differ from those of the macro cell subframe.

The data channel for the LTE-A UE in the HetNet cell subframe can be allocated in the HetNet cell subframe corresponding to the region except for the control channel region in the macro cell subframe.

In order to configure this structure, the eNB provides different system configuration information to the LTE UE and LTE-A UE.

For the LTE UE, new information is not provided in addition to the conventional system information, or, in other words, the new information can be detected by the LTE-A system but not by the LTE UE system.

For the LTE-A UE, the control channel region information for ICIC in the macro cell or HetNet cell can be provided by means of a PBCH or higher layer signaling.

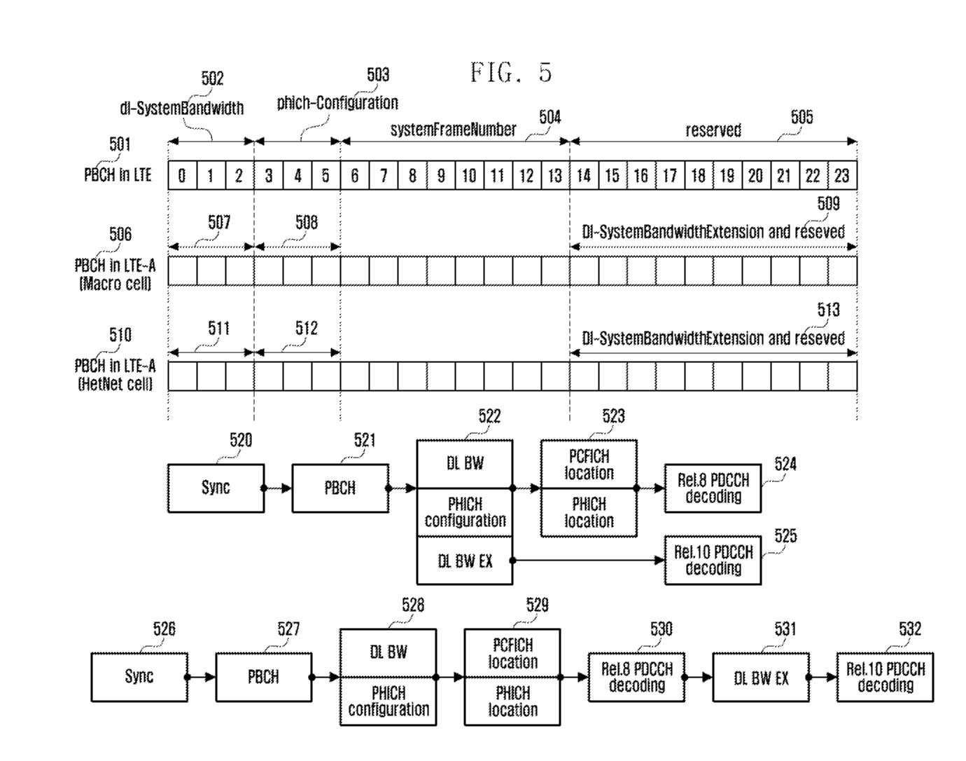

FIG. 5 illustrates a signaling procedure for LTE-A ICIC according to an exemplary embodiment of the present invention.

Referring to FIG. 5, a description is made of the method for providing the LTE-A UE with the control channel region information via a PBCH in a macro cell or a HetNet cell.

A PBCH in LTE 501, which is PBCH information of the legacy LTE system, is shown in FIG. 5. The PBCH is 24 bits long, and the first three bits are d1-SystemBandwidth information 502 carrying downlink bandwidth information. The next three bits are PHICH-configuration information 503, carrying PHICH configuration information. The next eight bits are a system frame number 504 indicating 8 Most Significant Bits (MSB) of a current frame number. The last bits are a reserved region 505 for future use. That is, the reserved region 505 is not recognized by the LTE terminal but can be used for providing new information to the LTE-A UE.

In a case of a macro cell, the eNB transmits the extended bandwidth information in a control channel region 509, which the LTE-A terminal recognizes as part of a PCBH in LTE-A 506, as shown in FIG. 5. The extended bandwidth information is carried in the a left region 402 and a right region 404, as shown in FIG. 4, and the extended bandwidth information indicates a remainder of a bandwidth after allocation of the control channel region for the HetNet cell in the region excluding the N symbols in the region used for the control channel of the macro cell subframe 436. The region can be indicated by the following two examples:
(1) a method using 1 bit for indicating whether the left region 402 or the right region 404 are used; or
(2) a predefined region indication method.

In a case of example (1), the 1 bit indicates which of the left and right regions 402 and 404 is used. For example, if the 1 bit indicates the use of the right region 404, the LTE UE can be scheduled in the regions 431 and 402. In a case of the predefined region indication method of example (2), the entire bandwidth of the micro cell subframe 436 is divided into N sections of 1/N in size, except for the region 409, and the actually used region is expressed in a bitmap form. This method can divide the bandwidth into up to 10 areas of 10 bits. Another method for indicating the usage region is to indicate the continuous region used by total log2(N) bit.

In a case of the HetNet cell, the eNB changes the downlink bandwidth 511 to the region 409 rather than the actually used bandwidth so as to notify the LTE UE of a bandwidth that is narrower than the actual bandwidth as an available bandwidth. Also, the eNB notifies the LTE-A terminal of the actual bandwidth information using the region 513. The bandwidth information transmitted to the LTE-A terminal in the region 513 is identical with the bandwidth information of 3 bits of the region 507.

With reference to FIGS. 4 and 5, a description is made of a method for notifying the LTE-A UE of the control channel region information in the macro cell or HetNet cell supporting ICIC hereinafter.

In this method, the PBCH 506 of the macro cell is used in a manner similar to that of the conventional method, and the PBCH 510 of the HetNet cell is configured with the information on the bandwidth narrower than the actual available bandwidth. The eNB notifies the LTE-A UE of the information by higher layer signaling and, in a case of the macro cell, sends the information in the region 402 and 404, which is the information on the remainder after allocation of the control channel region of the HetNet cell in the region except for the N symbols of the region used for a control channel in macro cell subframe.

For the HetNet cell, the eNB sends the LTE-A UE the information on the entire bandwidth as being available. This method is advantageous in that the left and right regions 402 and 404 can be freely configured because the higher layer signaling has no limit as compared to the notification using the PBCH, which should be configured with fixed number of bits. The above described two procedures are summarized below.

According to the present exemplary method for notifying the LTE-A UE of the control channel configuration information of the macro cell and the HetNet cell via the PBCH, the LTE-A receives the synchronization signal (520) and then the PBCH (521). The PBCH is transmitted as shown in PCBH in LTE-A 506 or PCBH in LTE-A 510 according to a type of the cell. The LTE UE and the LTE-A UE receive new bandwidth information DL BW EX, a downlink bandwidth (DL BW) and PHICH configuration information (522). The LTE-A UE recognizes a PCFICH location and a PHICH location using the conventional information (523), and decodes the LTE PDCCH using the PCFICH location and PHICH location (524), and the decodes the LTE-A control channel region using the new bandwidth information (DL BW EX) (525).

According to the present exemplary embodiment, using higher layer signaling, all of the UEs decode the PDCCH (530) using the conventional information (526 to 529), and receive the new control channel information, which is also the DL BW EX, (531) via the higher layer signaling, and then decode the new control channel using the new control channel information in step 532.

The left and right regions 402 and 404, which are also referred to as the new control channel regions 402 and 404 of the macro cell subframe 436, can be configured as the conventional PDCCH or as E/R-PDCCH for allocating the control channel in unit of a new Physical Resource Block (PRB).

In a case of the region 425 of the HetNet cell subframe, the last symbol in which the LTE terminal transmits data can overlap with the region 401 so as to cause interference. Although the interference is tiny in the region 401, because this region is used for diversity transmission of a control channel, the HetNet eNB can decrease the transmit power of the symbol in the region 425. This is the case for the next symbol in the region of the bandwidth 436. That is, in order to support ICIC between control channels, the eNB determines the power allocation for symbols as well as the power allocation per PRB in consideration of the control channel regions of the hierarchical cells.

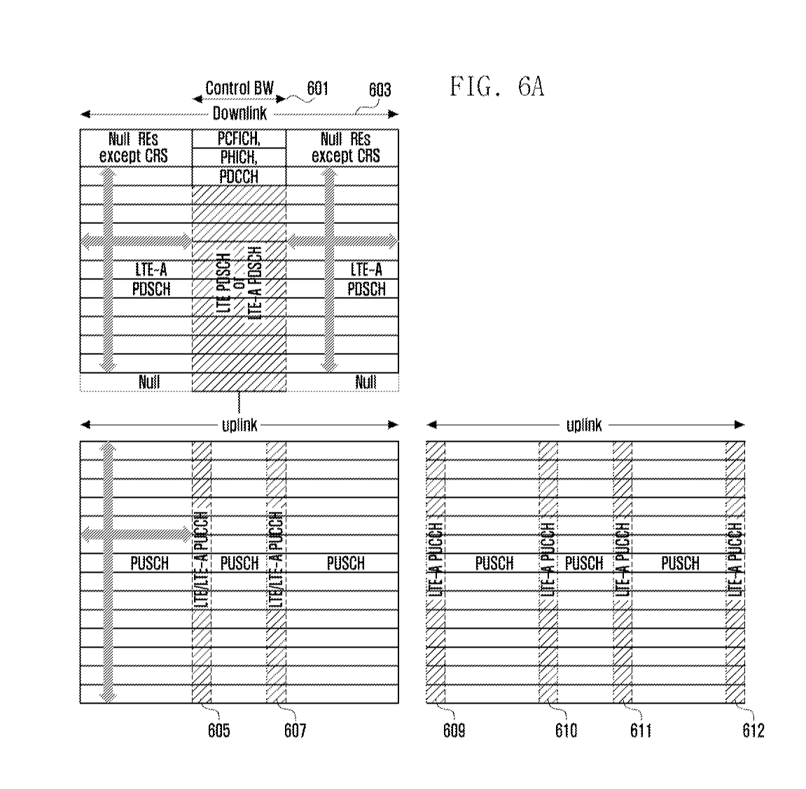

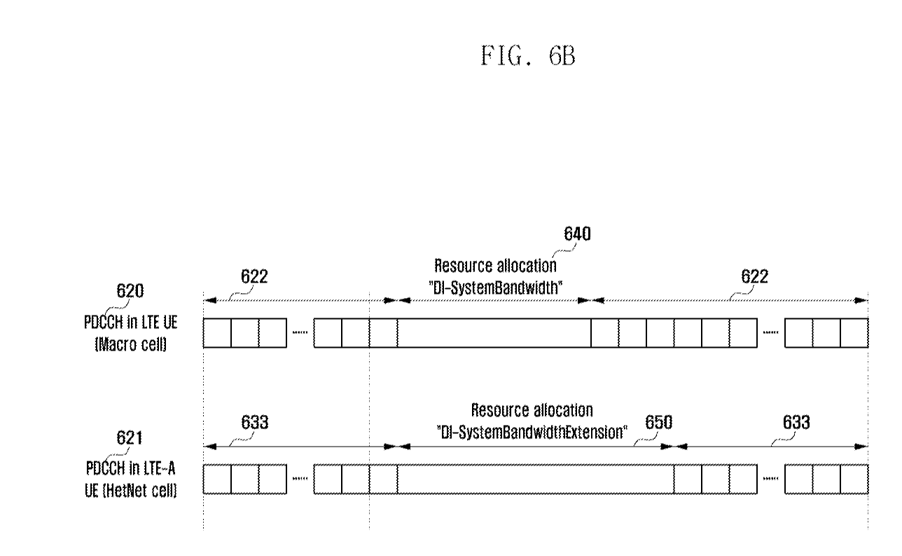

FIG. 6A illustrates structures of an uplink control channel for indicating different bandwidths to LTE and LTE-A UEs in a HetNet cell according to an exemplary embodiment of the present invention.

In a legacy LTE system, a downlink bandwidth is identical in size to an uplink bandwidth, such that the uplink bandwidth is disposed at both sides of an entire bandwidth of the legacy LTE system. Referring to FIG. 6A, in the system according to an exemplary embodiment of the present invention, since different bandwidths assigned for the LTE UE and the LTE-A UE in a control channel configuration of the HetNet cell subframe, locations of the control channels are changed. FIG. 6A shows a LTE UE bandwidth 601 and a LTE-A UE bandwidth 603. In the present case, an uplink bandwidth can be configured to have a same size of the LTE UE bandwidth 601 and thus both the LTE and LTE-A UEs can use a same region. Alternatively, bandwidths 610 and 611 which are recognized by the LTE UE can be used as a control channel for the LTE UE, and bandwidths 609 and 612, which are recognized by the LTE-A UE, can be used as a control channel for the LTE-A UE.

FIG. 6B illustrates a structure of a scheduling control channel information received by LTE and LTE-A UEs within the HetNet cell in a bandwidth information acquisition process according to an exemplary embodiment of the present invention.

Referring to FIGS. 4, 5, and 6B, the LTE UE receives a control channel 620 in the HetNet cell, discriminates between resource allocation information 640 and other information 622 in the control channel 620. The LTE UE configures a region 640 based on information carried in the d1-SystemBandwidth information 502, and receives data in the region 426. Meanwhile, the LTE-A UE receives a control channel 621, discriminates between the resource allocation information 650 and other information 633 in the control channel 621, configures resource allocation information 650 based on the information carried in the region 513, and receives the data scheduled in the HetNet cell subframe 407.

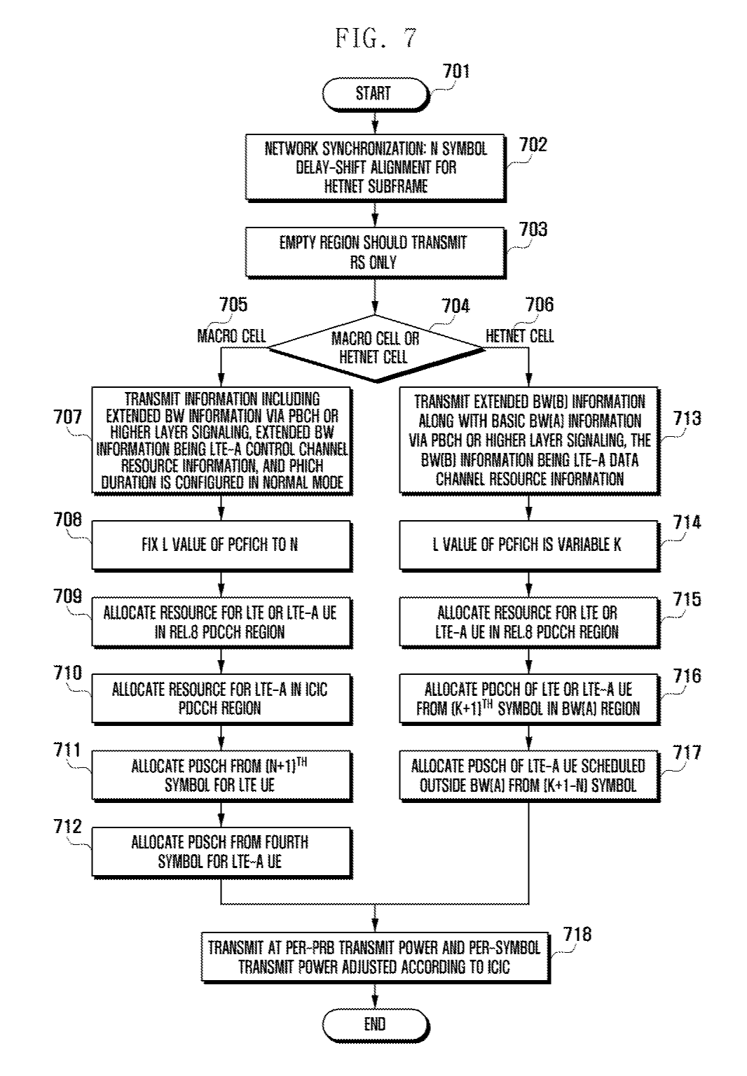

FIG. 7 is a flowchart illustrating operations of a transmitter of eNB according to an exemplary embodiment of the present invention.

Referring to FIG. 7, the eNB first performs subframe synchronization between the macro and HetNet cells as the HetNet cell subframe is shifted as much as N symbols in relation to the macro cell subframe, which is a delay-shift in step 702. Space vacated by the delay shift is configured to transmit Reference Signals (RS), but is not for transmitting data, in step 703. Next, the eNB determines whether to configure a macro cell control channel or a HetNet cell control channel in step 704.

If the macro cell control channel is to be configured, the procedure branches out via step 705, such that the eNB sends the control channel region information, or extended bandwidth information, for ICIC between control channels via the PBCH or higher layer signaling in step 707. In a case of using the PBCH, the control channel information extended from the conventional information is transmitted such that only the LTE-A UE can access the extended control channel. In a case of using higher layer signaling, the eNB notifies the LTE-A UE of the ICIC control channel region information by higher layer signaling without changing the bandwidth information of the PBCH. The eNB transmits a PHICH configured according to a value of N in both methods, and the eNB configures a PHICH duration in normal mode, which means that the PHICH is transmitted in the first symbol.

The eNB sets the value of L as the CFI value of the PCFICH to a fixed constant of N in step 708, and assigns N symbols for the control channel information of the LTE or LTE-A UE, which is a Rel. 8 PDCCH region indicated by PCFICH, in step 709. Next, the eNB assigns the LTE-A control channel region for scheduling information of the LTE-A UE in step 710. The LTE-A control channel region consists of the left and right regions 402 and 404 remaining after allocation of the control channel region for HetNet cell in the region except for the N symbols in the region used for the control channel in the macro cell subframe.

Next, the eNB assigns the data channel from the (N+1)^{th} symbol to the LTE UE based on the scheduling information in step 711. Sequentially, the eNB assigns the data channel following the maximum PDCCH region to the LTE-A UE in step 712. Here, the maximum PDCCH region is up to a third symbol for the bandwidth wider than 1.6 Mhz and a fourth symbol for the bandwidth less than 1.6 Mhz Step 712 is the latter case. Finally the eNB transmits the macro cell subframe carrying data channel with per-PRB power allocation and per-symbol power allocation according to the ICIC information in step 718.

If, at step 704, it is determined that the HetNet cell control channel is to be configured, then, the procedure branches out via step 706. The eNB transmits information on the bandwidth for use in HetNet cell, which is an ICIC control bandwidth, and which is narrower than an actually usable bandwidth via the PBCH.

Next, the eNB informs the LTE-A UE of the entire bandwidth that can be actually used in the HetNet. In this case, the information on the entire bandwidth can be sent to the LTE-A UE by means of the PBCH or higher layer signaling in step 713.

Meanwhile, a value of L indicated by the CFI of PCFICH for HetNet cell is set to the variable K in step 714.

In the HetNet cell, the eNB sends the scheduling information in the control channel region 409 (see FIG. 4) via the PBCH regardless of there being a LTE UE or a LTE-A in step 715. Next, the eNB maps the data channel of the LTE or LTE-A UE in the region notified via the PBCH from (K+1)^{th} symbol in step 716. The eNB also assigns resources for the data of the LTE-A UE in a remaining region of the bandwidth from (K+1−N)^{th} symbol in step 716. That is, the data channel of the LTE-A UE is mapped to the resources across the entire bandwidth that can be usable.

Once the data channel mapping has been completed, the eNB completes the scheduling in the current subframe with transmit power allocation according to the ICIC information in step 718.

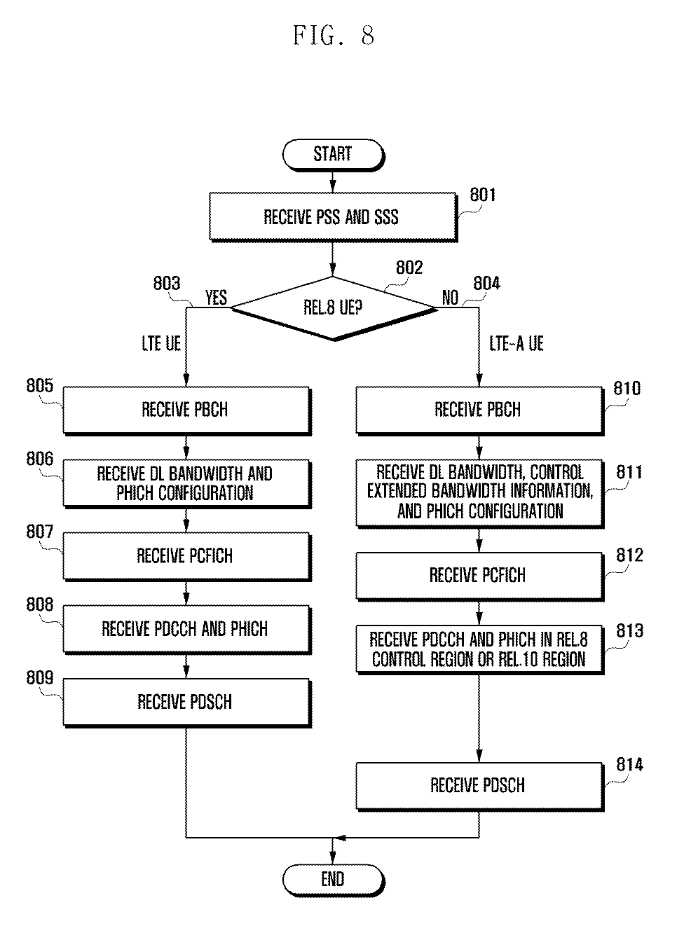

FIG. 8 is a flowchart illustrating operations of the UE for receiving data according to an exemplary embodiment of the present invention.

FIG. 8 is directed to the case where the ICIC information of a control channel is provided via the PBCH. Referring to FIG. 8, the UE receives the synchronization signal, PSS and SSS, in step 801, and, if the UE is determined to be a Release 8 (Rel. 8) UE in step 802, then, the procedure branches out via step 803 to receive a PBCH in step 805. After receiving the PBCH in step 805, the UE extracts the downlink bandwidth information and PHICH configuration information in step 806. Next, the UE receives a value for N via a PCFICH in step 807 and then receives PDCCH and PHICH in the control channel region of N symbols in step 808. Finally, the UE receives data channel from (N+1)^{th} symbol in step 809.

If the UE is determined to be an LTE-A UE at step 802, the procedure branches out via step 804 to receive a PBCH in step 810 and acquire current bandwidth information, PHICH configuration information, and extended bandwidth information for an ICIC control channel from the PBCH in step 811. Next, the UE receives PCFICH to acquire the value for N in step 812. Next, in step 813, the UE receives a PDCCH and a PHICH based on the control channel resource information.

In a case of the macro cell, the UE receives data channel from the symbol after maximum value of L in step 814. The data channel is received from a fourth symbol for the bandwidth wider than 1.6 Mhz and from a fifth symbol for the bandwidth narrower than 1.6 Mhz

Meanwhile, in a case of the HetNet cell, the UE receives a data channel extending from a (K+1)^{th} symbol to a last symbol for the PRB allocated in basic bandwidth information, or the UE receives a data channel extending from a (K+1−N)^{th} symbol to the Nth symbol back from a last symbol in the remainder region of the bandwidth.

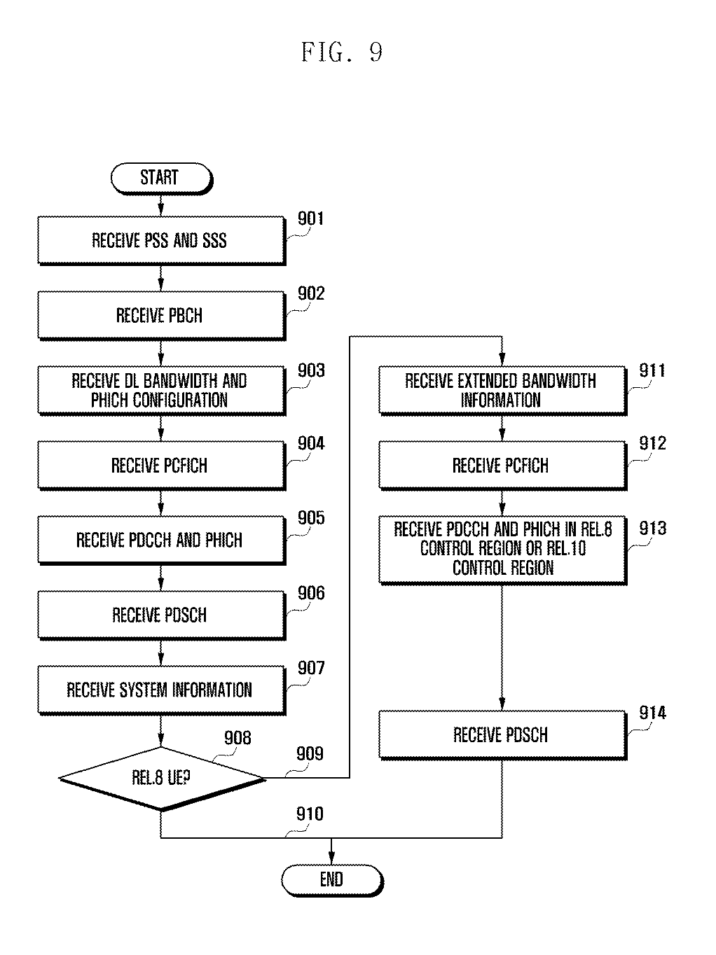

FIG. 9 is a flowchart illustrating operations of the UE for receiving data according to an exemplary embodiment of the present invention.

FIG. 9 is directed to a case where the ICIC information of a control channel is provided by higher layer signaling. Referring to FIG. 9, the UE receives synchronization signals, PSS and SSS, in step 901, and then receives a PBCH in step 902. Next, the UE acquires downlink bandwidth information and PHICH configuration information from the PBCH in step 903. Here, the PBCH includes the information on the bandwidth having a certain width within the usable bandwidth. That is, the bandwidth informed by the PBCH is narrower than the actually usable bandwidth. Next, the UE receives PCFICH to acquire the value of N for the macro cell or the value of K for HetNet cell, in step 904, and then receives PDCCH and PHICH in the control channel region in step 905. Then, in step 906, the UE receives data channel from (N+1)^{th} symbol in step 906.

The UE receives system information in step 907 and, in a case of there being a LTE-A UE as determined in step 908, the procedure branches via step 909 in order to acquire the extended bandwidth information for the ICIC control channel via higher layer signaling in step 911. Next, the UE receives a PCFICH and acquires the value of N or K from the PCFICH in step 912. Then, the UE receives the PDCCH and the PHICH by using the received control channel information in step 913.

In a case of the macro cell, the UE receives a data channel from the symbol after a maximum value of L symbols in step 914. The data channel is received from the fourth symbol for a bandwidth wider than 1.6 Mhz and from the fifth symbol for a bandwidth narrower than 1.6 Mhz Meanwhile, in a case of the HetNet cell, the UE receives the data channel extending from the (K+1)^{th} symbol to the last symbol for the PRB allocated in basic bandwidth information or receives the data channel extending from the (K+1−N)^{th} symbol to the Nth symbol back from the last symbol in the remainder region of the bandwidth. In this case, the LTE-A UE can receive the data channel for the entire usable bandwidth.

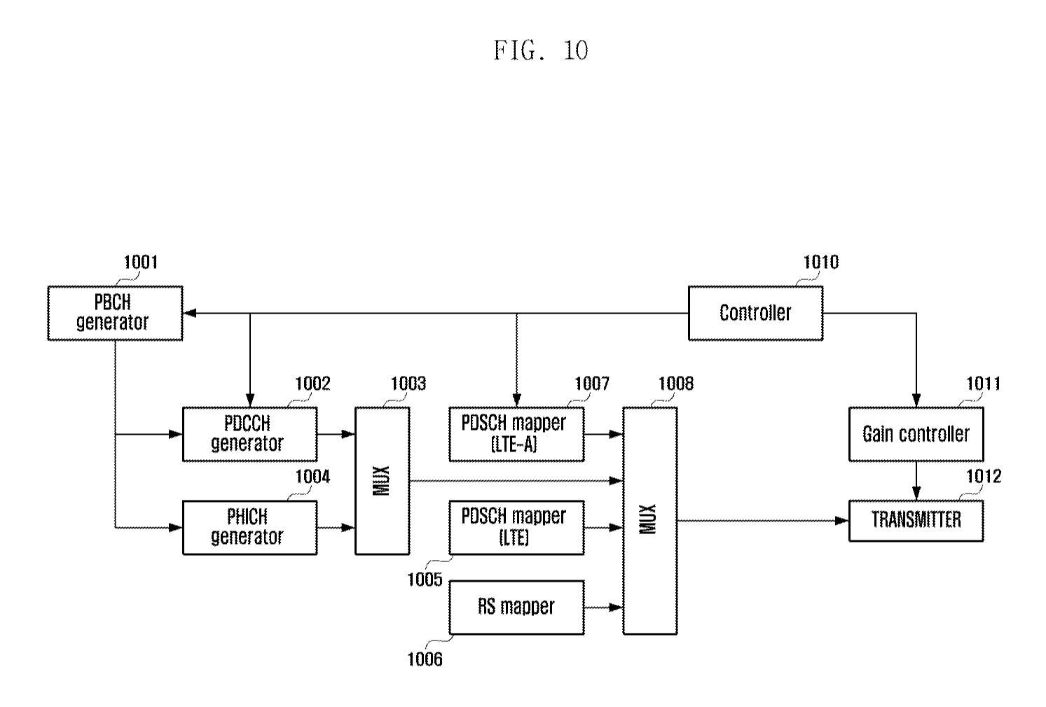

FIG. 10 is a block diagram illustrating a configuration of the eNB according to an exemplary embodiment of the present invention.

A controller 1010 configures information on a PBCH generator 1001 for supporting ICIC control channel. The controller 1010 controls a PDCCH generator 1002 and a PHICH generator 1004 in order to generate a control channel based on the configured information. In more detail, the controller 1010 designates a first of N symbols of the macro cell frame as the control channel for a first UE when configuring the macro cell frame. Next, the controller 1010 designates a region corresponding to the N symbols and a region used for the control channel of HetNet cell as a control channel for a second UE.

The controller 1010 synchronizes the HetNet cell subframe in the shifted state shifted to be delayed as much as N symbols, which are designated as the control channel for the first UE, with the macro cell subframe in configuring the HetNet cell subframe. The controller 1010 also configures a narrower bandwidth than an actual bandwidth that can be used in the HetNet cell to be an available bandwidth when configuring the control channel of the HetNet cell subframe. The configured bandwidth can be commonly used by both the first and second UE. The controller 1010 also can configure the entire usable bandwidth in the HetNet cell as a bandwidth available for the second UE.

The control channels configured as above are multiplexed by the multiplexer 1003.

The controller 1010 transmits the control channel configuration information of the macro cell subframe and the HetNet cell subframe to the first UE and/or the second UE by means of the PBCH or higher layer signaling. In more detail, the controller 1010 transmits information on the control channel region for the second UE in the macro cell subframe by means of bits or a bitmap or directly by higher layer signaling.

For the HetNet cell, the controller 1010 controls transmission of the information on the bandwidth narrower than the bandwidth actually available in the HetNet cell to be transmitted via the PBCH. In this case, the first and second UEs recognize the narrow bandwidth as the bandwidth available in the HetNet cell. Simultaneously, the controller 1010 controls such that the information on the bandwidth actually usable in the HetNet cell to the second UE by means of the PBCH or higher layer signaling. In this case, the second UE recognizes the entire bandwidth as the bandwidth available in the HetNet cell.

The controller 1010 also exchanges information with a controller of a neighbor HetNet or macro cell and controls to maintain synchronization between cells without interference of the control channels.

The control channel generated by the PDCCH generator 1002 includes the legacy LTE control channel and the LTE-A control channel. The controller 1010 configures the data channel of the LTE-A UE by means of the PDSCH mapper 1007 for the LTE-A UE and the data channel of the LTE UE by means of the PDSCH mapper 1005 for LTE terminal simultaneously according to the control channel. The data channels are multiplexed with Reference Signals (RS) of the RS mapper 1006 by the multiplexer 1008. The controller 1010 controls the gain controller 1011 to adjust a transmit power of the transmitter 1012 per PRB or symbol in order to perform ICIC effectively.

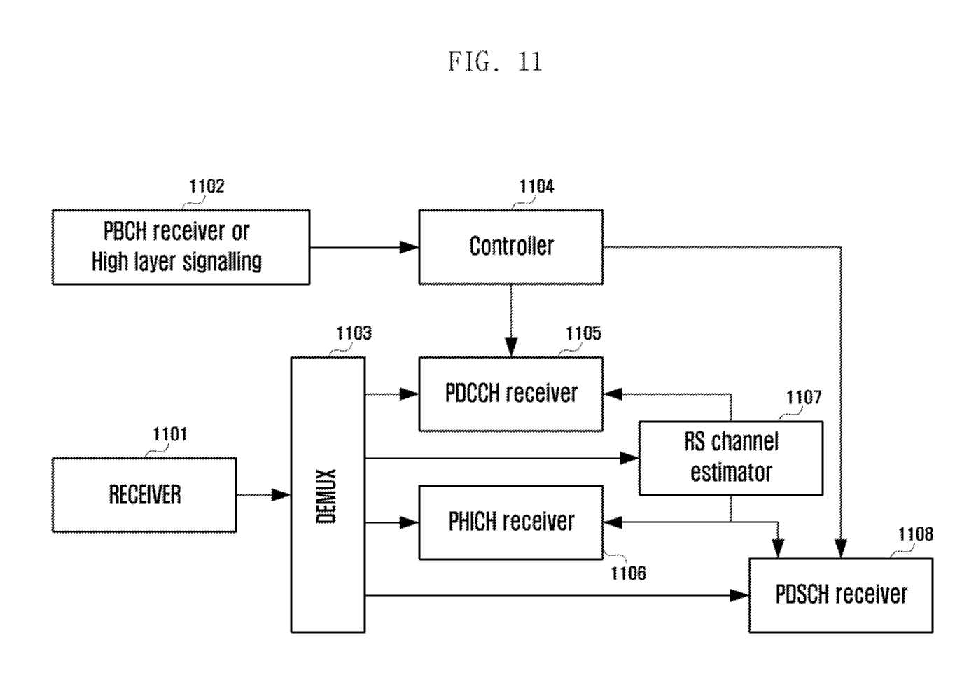

FIG. 11 is a block diagram illustrating a configuration of the receiver of a UE according to an exemplary embodiment of the present invention.

Referring to FIG. 11, a signal received by a receiver 1101 is demultiplexed by the demultiplexer 1103 such that the RS channel estimator 1107 acquires estimated channel information and a PDCCH receiver 1105 acquires a control channel from the demultiplexed signal. At this time, a controller 1104 locates a control channel region based on the ICIC control information 1102 received by means of the PBCH or higher layer signaling.

In more detail, the controller 1104 can determine whether the cell which the receiver is connected to a macro cell or a HetNet cell. If the receiver is connected to the macro cell, the controller 1104 controls receiving a control channel such that the control channel is received in a region designated as the control channel for the first UE and the region remaining after allocating the region for the control channel of the HetNet cell in the macro cell subframe.

If the receiver is connected to the HetNet cell, the controller 1104 controls a PCBH such that the information on the bandwidth narrower than the bandwidth actually usable in the HetNet cell is first received via the PBCH. Next, the controller 1104 controls the PCBH such that the information on the bandwidth which is actually used in the HetNet cell is transmitted by means of the PBCH or higher layer signaling. Accordingly, the UE receives the control channel in the HetNet cell subframe having a size of entire bandwidth that can be used in the HetNet cell.

Once the control channel is received completely, the controller 1104 receives data channel based on the scheduling information by means of the PDSCH receiver 1108.

The Inter-Cell Interference (ICI) method and apparatus of the exemplary embodiments discussed above is capable of configuring control channels so as to mitigate ICI of control channels of cells in a hierarchical cellular system. Also, the ICI method and apparatus of exemplary embodiments of the present invention is advantageous for mitigating ICI of control channels while maintaining backward compatibility with legacy LTE UEs by configuring a control channel dedicated to a LTE-A UE that can be received by only the LTE-A UE. Furthermore, the ICI method and apparatus of exemplary embodiments of the present invention enables the LTE-A UE to receive the control channel without interference so as to support ICIC transmission.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An inter-cell interference control method of a base station in a hierarchical cellular system based on Orthogonal Frequency Division Multiplexing (OFDM), the method comprising:
transmitting a broadcast channel, including information on an available bandwidth that is a part of an entire bandwidth, to a terminal;
transmitting a control channel including data channel allocation information for the entire bandwidth to the terminal; and
transmitting a data channel, as informed by the data channel allocation information, to the terminal.

2. The method of claim 1, wherein the transmitting of the broadcast channel comprises transmitting information on the entire bandwidth in the broadcast channel.

3. The method of claim 1, further comprising transmitting information on the entire bandwidth to the terminal by higher layer signaling.

4. The method of claim 1, wherein the control channel and the data channel of a cell are transmitted in a subframe of which start and end points differ from those of a subframe transmitted by another cell in the hierarchical cellular system.

5. The method of claim 1, wherein the data channel is mapped to a region remaining after allocation of a control channel region in a subframe for a macro cell in the hierarchical cellular system.

6. A method for receiving control and data channels of a terminal in a hierarchical cellular system based on Orthogonal Frequency Division Multiplexing (OFDM), the method comprising:
receiving a broadcast channel including information on an available bandwidth that is a part of an entire bandwidth;
receiving a control channel including data channel allocation information for the entire bandwidth; and
receiving a data channel according to the data channel allocation information.

7. The method of claim 6, wherein the receiving of the broadcast channel comprises receiving information on the entire bandwidth from a base station via the broadcast channel.

8. The method of claim 6, further comprising receiving information on the entire bandwidth from a base station by higher layer signaling.

9. The method of claim 6, wherein the control channel and the data channel of a cell are received in a subframe of which start and end points differ from those of a subframe transmitted by another cell in the hierarchical cellular system.

10. The method of claim 6, where the data channel is mapped to a region remaining after allocation of a control channel region in a subframe for a macro cell in the hierarchical cellular system.

11. A base station for controlling inter-cell interference in a hierarchical cellular system based on Orthogonal Frequency Division Multiplexing (OFDM), the base station comprising:
a controller for generating a broadcast channel including information on an available bandwidth that is a part of an entire bandwidth, a control channel including data channel allocation information for the entire bandwidth, and a data channel based on the data channel allocation information; and
a transceiver for transmitting the broadcast channel, the control channel, and the data channel to a User Equipment (UE).

12. The base station of claim 11, wherein the controller controls the transceiver to transmit information on the entire bandwidth in the broadcast channel.

13. The base station of claim 11, wherein the controller controls the transceiver to transmit information on the entire bandwidth by higher layer signaling.

14. The base station of claim 11, wherein the control channel and the data channel of a cell are transmitted in a subframe of which start and end points differ from those of a subframe transmitted by another cell in the hierarchical cellular system.

15. The base station of claim 11, wherein the data channel is mapped to a region remaining after allocation of a control channel region in a subframe for a macro cell in the hierarchical cellular system.

16. A terminal for receiving control and data channels in a hierarchical cellular system based on Orthogonal Frequency Division Multiplexing (OFDM), the terminal comprising:
a transceiver for receiving the control and data channels transmitted by a base station; and
a controller for receiving and processing a broadcast channel including information on an available bandwidth that is a part of an entire bandwidth, a control channel including data channel allocation information for the entire bandwidth, and a data channel according to the data channel allocation information.

17. The terminal of claim 16, wherein the controller controls the transceiver to receive information on the entire bandwidth from a base station via the broadcast channel.

18. The terminal of claim 16, wherein the controller controls the transceiver to receive information on the entire bandwidth from a base station by higher layer signaling.

19. The terminal of claim 16, wherein the control and data channels of a cell are received in a subframe of which start and end points differ from those of a subframe transmitted by another cell in the hierarchical cellular system.

20. The terminal of claim 16, wherein the data channel is mapped to a region remaining after allocation of a control channel region in a subframe for a macro cell in the hierarchical cellular system.
